(19) United States
(12) Patent Application Publication
(10) Pub. No.: US 2016/0253021 A1
(43) Pub. Date: Sep. 1, 2016

(54) METHOD AND CIRCUIT FOR DISPLAY PANEL TO SUPPLY SYNC SIGNAL TO TOUCH PANEL

(71) Applicant: SHENZHEN CHINA STAR OPTOELECTRONICS TECHNOLOGY CO., LTD., Shenzhen, Guangdong (CN)

(72) Inventors: Shensian SYU, Shenzhen, Guangdong (CN); Chunhuai LI, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/424,137

(22) PCT Filed: Oct. 16, 2014
(86) PCT No.: PCT/CN2014/088729

§ 371 Date: Feb. 26, 2015

(30) Foreign Application Priority Data
Sep. 25, 2014 (CN) 201410499590.7

(51) Int. Cl. G06F 3/041; G06F 3/044

(52) U.S. Cl. CPC G06F 3/0416; G06F 3/0412; G06F 3/044

(57) ABSTRACT

The present invention provides a method and a circuit for a display panel to supply a sync signal to a touch panel. The method includes Step 1: providing a display panel (1) and a touch panel (3); Step 2: forming a driving block (51) on the display panel (1); Step 3: connecting the driving block (51) via a lead wire to a sync signal output pin of the display drive IC (15); Step 4: forming a sensing block (53) on the touch panel (3) such that the driving block (51) and the sensing block (53) constitute a capacitor C; Step 5: connecting the sensing block (53) via a lead wire to a sync signal input pin of the touch controller IC (35); and Step 6: the display drive IC (15) generating a sync signal that is outputted through the sync signal output pin thereof to be sensed by the capacitor C to generate a sensing signal such that the sensing signal is transmitted to the touch controller IC (35) to be sensed by a capacitor of the touch controller IC (35) to obtain the sync signal.

### BACKGROUND OF THE INVENTION

1. Field of the Invention

The present invention relates to the field of touch display technology, and in particular to a method and a circuit for a display panel to supply a sync signal to a touch panel.

2. The Related Arts

With the progress of the display technology, due to various advantages including high image quality, low power consumption, thin device body, and a wide range of applications, flat panel display devices are widely used in various consumer electronic products, such as mobile phones, televisions, personal digital assistants (PDAs), digital cameras, notebook computers, and desktop computers, making them a main stream of display devices.

A touch panel provides a novel man-machine interactive interface and the use is direct and user-friendly. Combing a touch panel with a flat panel display provides a touch display device, which provides the flat panel display with a touch control function so that inputs can be executed through fingers and touch stylus, making the operation straightforward and easy.

Since a touch display device possesses both a touch detection function and an image displaying function, to prevent mutual interference between the operations of touch detection and image displaying to affect the accuracy of touch detection or the clearness and smoothness of image displaying, it is necessary to avoid noise induced between the display panel and the touch panel.

Referring to FIG. 1, in the known arts, to prevent noise generated between a display panel 60 and a touch panel 70, it is a common practice to generate and transmit a sync signal from a drive IC (Integrated Circuit) 10 of the display panel 60 to a touch controller IC 30 of the touch panel 70. To transmit the sync signal from the drive IC 10 of the display panel 60 to the touch controller IC 30, a display panel flexible printed circuit assembly (FPCA) 20 and a touch panel FPCA 40 must be respectively provided with additional pins and transmission is done through a system board 50.

Such a known way of supplying a sync signal from the display panel to the touch panel requires increasing the number of pins of the display panel FPCA and the touch panel FPCA and an additional signal must be included in the system side. These increase the complication of design.

### SUMMARY OF THE INVENTION

An object of the present invention is to provide a method for a display panel to supply a sync signal to a touch panel, which reduces the number of pins of a display panel flexible printed circuit assembly and a touch panel flexible printed circuit assembly so that no additional signal needs to be included in the system side thereby reducing the complication of design.

Another object of the present invention is to provide a circuit for a display panel to supply a sync signal to a touch panel, which reduces the number of pins of a display panel flexible printed circuit assembly and a touch panel flexible printed circuit assembly so that no additional signal needs to be included in the system side thereby reducing the complication of design.

To achieve the above objects, the present invention firstly provides a method for a display panel to supply a sync signal to a touch panel, which comprises the following steps:

Step 1: providing a display panel and a touch panel;

the display panel comprising a display drive integrated circuit (IC);

the touch panel comprising a touch controller IC;

Step 2: forming a driving block on the display panel;

Step 3: connecting the driving block via a lead wire to a sync signal output pin of the display drive IC;

Step 4: forming a sensing block on the touch panel at a location exactly corresponding to the driving block so that the driving block and the sensing block form a capacitor C;

Step 5: connecting the sensing block via a lead wire to a sync signal input pin of the touch controller IC; and

Step 6: the display drive IC generating a sync signal in a horizontal blank interval or a vertical blank interval of the display panel and outputted through the sync signal output pin thereof to be sensed by the capacitor C to generate a sensing signal such that the sensing signal is transmitted to the touch controller IC to be sensed by a capacitor of the touch controller IC to obtain the sync signal.

The display panel further comprises an array substrate, a color filter substrate opposite to the array substrate, and a display panel flexible printed circuit assembly (FPCA); and the touch panel further comprises a plurality of touch sensors and a touch panel FPCA electrically connected to the plurality of touch sensors, the touch panel FPCA being electrically connected to the touch controller IC; the driving block is arranged in a circumferential area of the array substrate; and the sensing block is formed on a surface of the touch panel FPCA that faces the circumferential area of the array substrate and at a location to be exactly opposite to the driving block.

The driving block is a metal electrode.

The driving block is an indium tin oxide (ITO) electrode.

The sensing block is a metal electrode.

The present invention also provides a circuit for a display panel to supply a sync signal to a touch panel, which comprises a display drive IC, a driving block connected via a lead wire to a sync signal output pin of the display drive IC, a sensing block opposite to the driving block, and a touch controller IC connected via a lead wire to the sensing block; and the driving block and the sensing block constitute a capacitor C.

The driving block is formed on the display panel and the sensing block is formed on the touch panel at a location exactly corresponding to the driving block.

The display panel comprises an array substrate, a color filter substrate opposite to the array substrate, and a display panel flexible printed circuit assembly and the touch panel comprises a plurality of touch sensors and a touch panel FPCA electrically connected to the plurality of touch sensors, the touch panel FPCA being electrically connected to the touch controller IC; and the driving block is arranged in a circumferential area of the array substrate; and the sensing block is formed on a surface of the touch panel FPCA that faces the circumferential area of the array substrate and at a location to be exactly opposite to the driving block.

The driving block is a metal electrode or an ITO electrode.

The sensing block is a metal electrode.

The efficacy of the present invention is that the present invention provides a method and a circuit for a display panel to supply a sync signal to a touch panel, wherein through the arrangement that a driving block and a sensing block are provided to constitute a capacitor, the driving block being directly connected to a sync signal output pin of the display drive IC via a the lead wire and the sensing block being directly connected to a sync signal input pin of the touch controller IC via a lead wire, when the display drive IC outputs a sync signal, the capacitor generates a sensing signal such that the sensing signal is transmitted to the touch controller IC to be sensed by a capacitor of the touch controller IC to obtain the sync signal, so that it is possible to avoid noises generated between the display panel and the touch panel and, compared to the known arts, the number of pins of the display panel FPCA and the touch panel FPCA can be reduced to make it not necessary for the system side to include an additional signal thereby reducing the complication of design.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing a conventional way of supplying a sync signal from a display panel to a touch panel;

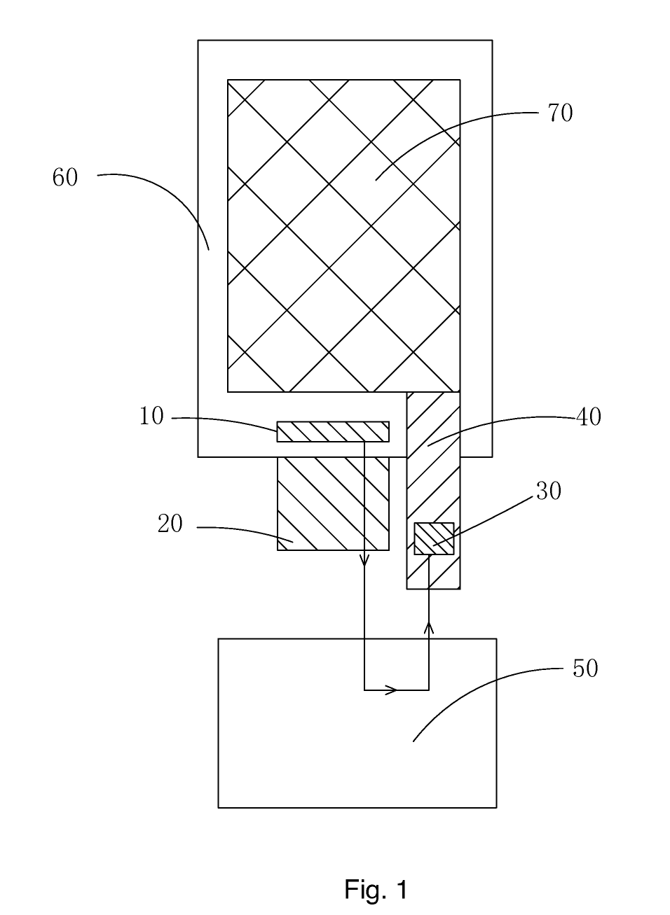

FIG. 2 is a flow chart illustrating a method for a display panel to supply a sync signal to a touch panel according to the present invention;

FIG. 3 is a schematic top plan view taken in a given direction to illustrate the method for a display panel to supply a sync signal to a touch panel according to the present invention and is also a schematic top plan view taken in the given direction to illustrate the circuit for a display panel to supply a sync signal to a touch panel according to the present invention;

FIG. 4 is a schematic top plan view taken in another given direction to illustrate the method for a display panel to supply a sync signal to a touch panel according to the present invention and is also a schematic top plan view taken in said another given direction to illustrate the circuit for a display panel to supply a sync signal to a touch panel according to the present invention;

FIG. 5 is a schematic cross-sectional view illustrating the method for a display panel to supply a sync signal to a touch panel according to the present invention and is also a schematic cross-sectional view illustrating the circuit for a display panel to supply a sync signal to a touch panel according to the present invention; and

FIG. 6 is a signal relationship diagram of the method for a display panel to supply a sync signal to a touch panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

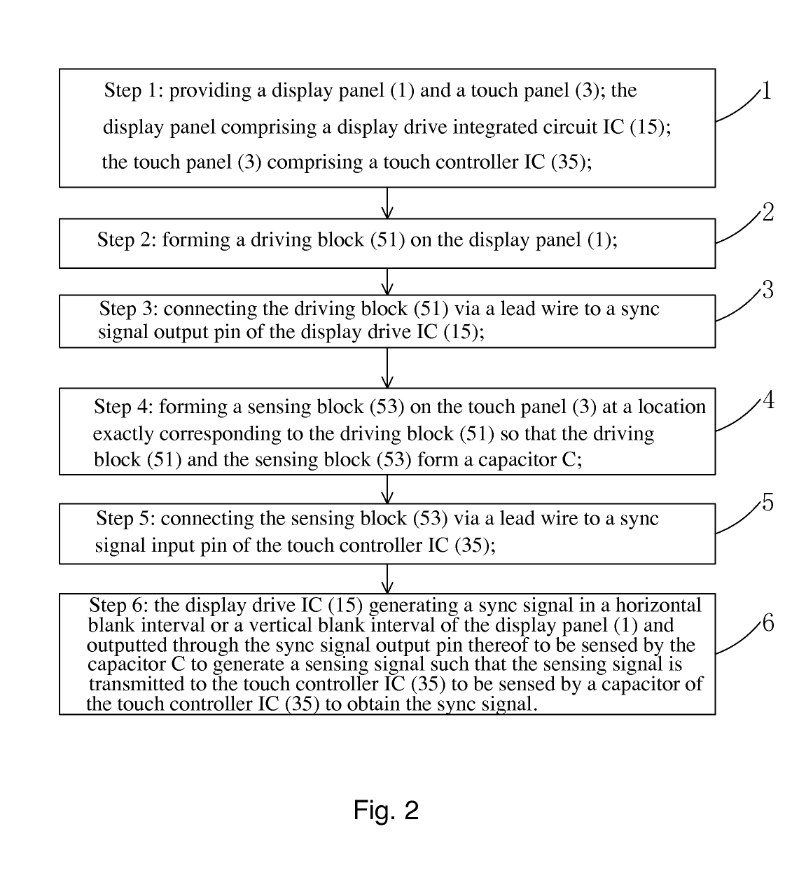

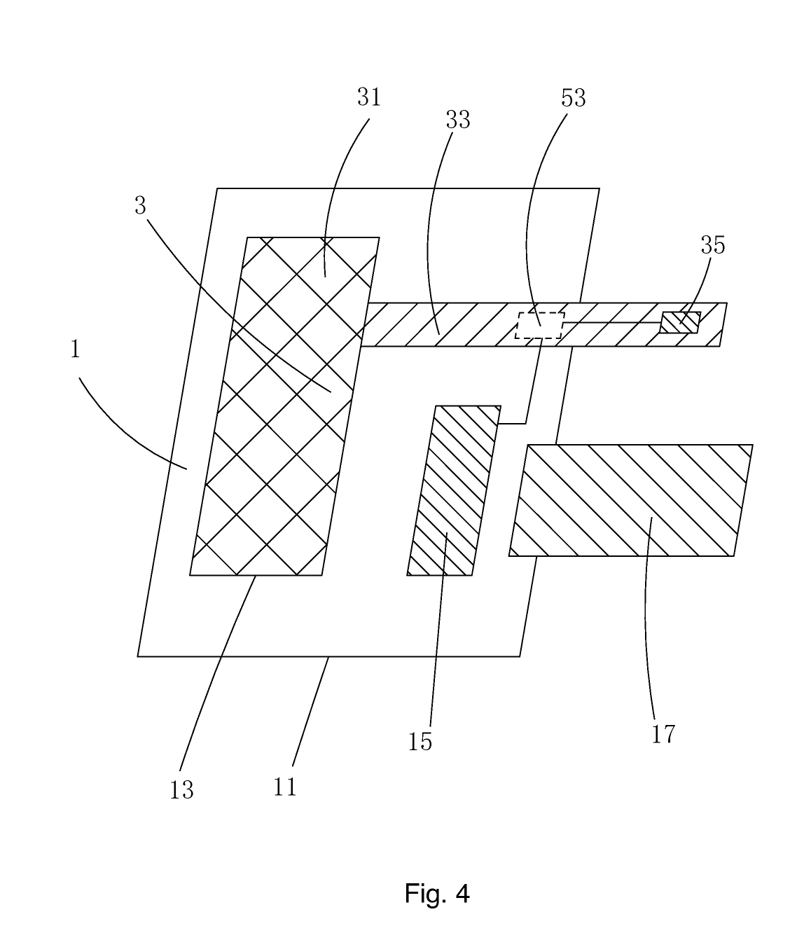

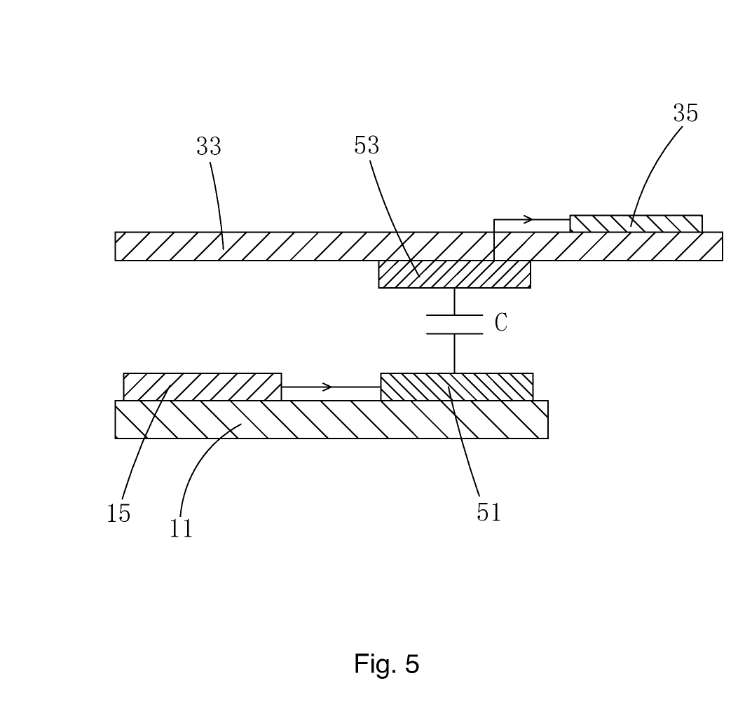

Referring to FIGS. 2-5, firstly, the present invention provides a method for a display panel to supply a sync signal to a touch panel, which comprises the following steps:

Step 1: providing a display panel 1 and a touch panel 3.

The display panel 1 comprises an array substrate 11, a color filter substrate 13 opposite to the array substrate 11, a display drive integrated circuit (IC) 15, and a display panel flexible printed circuit assembly (FPCA) 17.

The touch panel 3 comprises a plurality of touch sensors 31, a touch panel FPCA 33 electrically connected to the plurality of touch sensors 31, and a touch controller IC 35 electrically connected to the touch panel FPCA 33.

The touch panel 3 can be a separate touch panel laminated on the color filter substrate 13 or can alternatively obtained through forming a plurality of touch sensors 31 on a surface of the color filter substrate 13.

Step 2: forming a driving block 51 on the display panel 1.

Specifically, the driving block 51 is arranged in a circumferential area of the array substrate 11. The driving block 51 can be made of metals or an indium tin oxide (ITO) film. In other words, the driving block 51 is a metal electrode or an ITO electrode.

Step 3: connecting the driving block 51 via a lead wire to a sync signal output pin of the display drive IC 15.

After Step 3 is completed, a sync signal generated by the display drive IC 15 can be transmitted through the lead wire to the driving block 51.

Step 4: forming a sensing block 53 on the touch panel 3 at a location exactly corresponding to the driving block 51 so that the driving block 51 and the sensing block 53 collectively form a capacitor C.

Specifically, the sensing block 53 is formed on a surface of the touch panel FPCA 33 that faces the circumferential area of the array substrate 11 and at a location to be exactly opposite to the driving block 51.

The sensing block 53 is made of metals. In other words, the sensing block 53 is a metal electrode.

After Step 4 is completed, the driving block 51 and the sensing block 53 that are opposite to each other collectively constitute the capacitor C. When the driving block 51 receives the sync signal supplied from the display drive IC 15, the capacitor C generates a sensing signal.

Step 5: connecting the sensing block 53 via a lead wire to a sync signal input pin of the touch controller IC 35.

After Step 5 is completed, a sensing signal generated by the capacitor C can be transmitted through the lead wire to the touch controller IC 35.

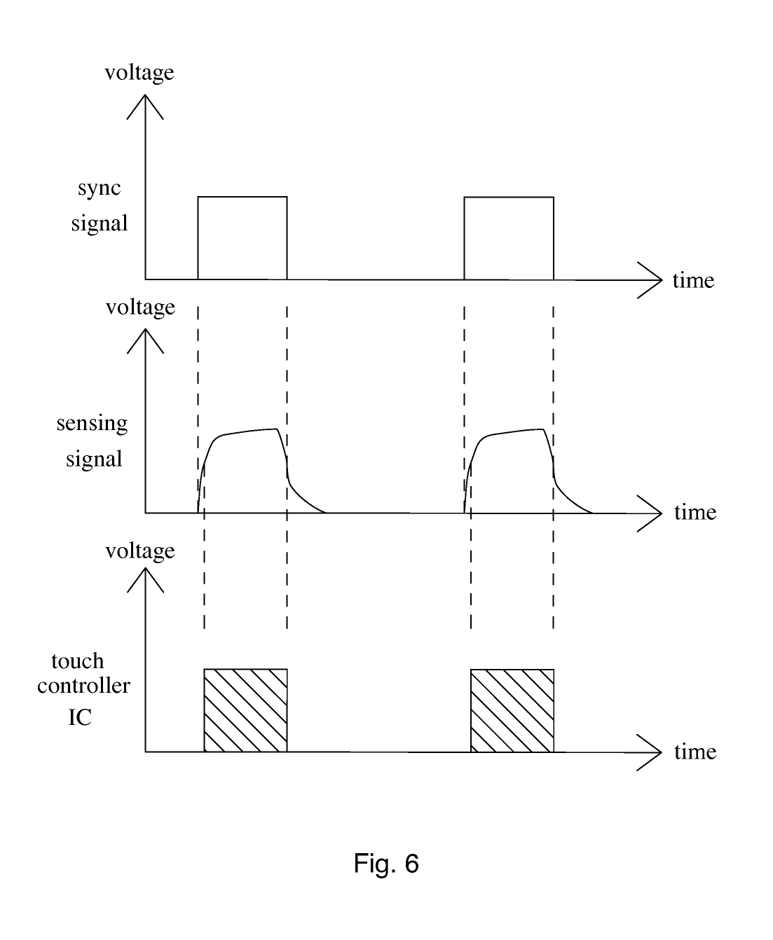

Step 6: as shown in FIG. 6, the display drive IC 15 generating a sync signal in a horizontal blank interval or a vertical blank interval of the display panel 1 and outputted through the sync signal output pin thereof to be sensed by the capacitor C to generate a sensing signal such that the sensing signal is transmitted to the touch controller IC 35 to be sensed by a capacitor of the touch controller IC 35 to obtain the sync signal.

During an active period of the sync signal, namely during the horizontal blank interval or the vertical blank interval of the display panel 1, the touch controller IC 35 carries out a sensing operation inside the touch panel 3 so as to prevent a noise generated between the display panel 1 and the touch panel 3.

Compared to the known arts, the above-described method for a display panel to supply a sync signal to a touch panel can reduce the numbers of pins of the display panel FPCA 17 and the touch panel FPCA 33 and makes it not necessary for the system side to include an additional signal thereby reducing the complication of design.

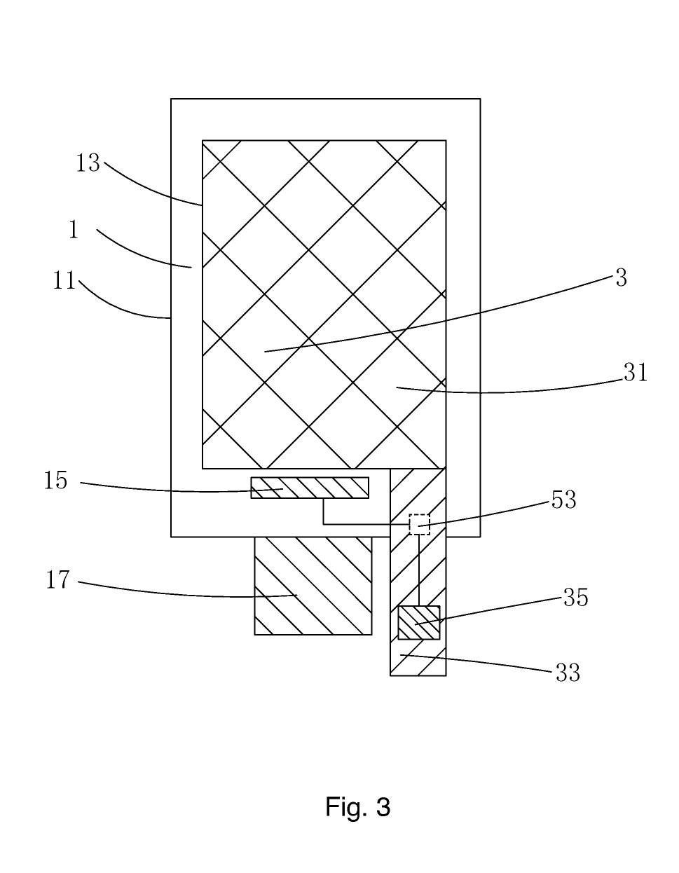

Referring collectively to FIGS. 3-5, the present invention also provides a circuit for a display panel to supply a sync signal to a touch panel, which comprises a display drive IC 15, a driving block 51 connected via a lead wire to a sync signal output pin of the display drive IC 15, a sensing block 53 opposite to the driving block 51, and a touch controller IC 35 connected via a lead wire to the sensing block 53. The driving block 51 and the sensing block 53 collectively constitute a capacitor C.

Specifically, the driving block 51 is formed on the display panel 1 and the sensing block 53 is formed on the touch panel 3 at a location exactly corresponding to the driving block 51.

Further, the display panel 1 comprises an array substrate 11, a color filter substrate 13 opposite to the array substrate 11, and a display panel FPCA 17 and the touch panel 3 comprises a plurality of touch sensors 31 and a touch panel FPCA 33 electrically connected to the plurality of touch sensors 31, the touch panel FPCA 33 being electrically connected to the touch controller IC 35. The driving block 51 is arranged in a circumferential area of the array substrate 11. The sensing block 53 is formed on a surface of the touch panel FPCA 33 that faces the circumferential area of the array substrate 11 and at a location to be exactly opposite to the driving block 51.

The driving block 51 is a metal electrode or an ITO electrode. The sensing block 53 is a metal electrode.

A sync signal generated by the display drive IC 15 can be transmitted directly through the lead wire to the driving block 51 so as to reduce the number of pins of the display panel FPCA 17. When the driving block 51 receives the sync signal supplied from the display drive IC 15, the capacitor C generates a sensing signal. The sensing signal is transmitted directly through the lead wire to the touch controller IC 35 to be sensed by a capacitor of the touch controller IC 35 to obtain the sync signal, thereby reducing the number of pins of the touch panel FPCA 33. During an active period of the sync signal, namely during, namely during a horizontal blank interval or a vertical blank interval of the display panel 1, the touch controller IC 35 carries out a sensing operation inside the touch panel 3 so as to prevent a noise generated between the display panel 1 and the touch panel 3.

In summary, the present invention provides a method and a circuit for a display panel to supply a sync signal to a touch panel, wherein through the arrangement that a driving block and a sensing block are provided to constitute a capacitor, the driving block being directly connected to a sync signal output pin of the display drive IC via a the lead wire and the sensing block being directly connected to a sync signal input pin of the touch controller IC via a lead wire, when the display drive IC outputs a sync signal, the capacitor generates a sensing signal such that the sensing signal is transmitted to the touch controller IC to be sensed by a capacitor of the touch controller IC to obtain the sync signal, so that it is possible to avoid noises generated between the display panel and the touch panel and, compared to the known arts, the number of pins of the display panel FPCA and the touch panel FPCA can be reduced to make it not necessary for the system side to include an additional signal thereby reducing the complication of design.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for a display panel to supply a sync signal to a touch panel, comprising the following steps:
Step 1: providing a display panel and a touch panel, wherein the display panel comprises a display drive integrated circuit (IC) and the touch panel comprises a touch controller IC;
Step 2: forming a driving block on the display panel;
Step 3: connecting the driving block via a lead wire to a sync signal output pin of the display drive IC;
Step 4: forming a sensing block on the touch panel at a location exactly corresponding to the driving block so that the driving block and the sensing block form a capacitor C;
Step 5: connecting the sensing block via a lead wire to a sync signal input pin of the touch controller IC; and
Step 6: the display drive IC generating a sync signal in a horizontal blank interval or a vertical blank interval of the display panel and outputted through the sync signal output pin thereof to be sensed by the capacitor C to generate a sensing signal such that the sensing signal is transmitted to the touch controller IC to be sensed by a capacitor of the touch controller IC to obtain the sync signal.

2. The method for a display panel to supply a sync signal to a touch panel as claimed in claim 1, wherein the display panel further comprises an array substrate, a color filter substrate opposite to the array substrate, and a display panel flexible printed circuit assembly (FPCA); and the touch panel further comprises a plurality of touch sensors and a touch panel FPCA electrically connected to the plurality of touch sensors, the touch panel FPCA being electrically connected to the touch controller IC; and
the driving block is arranged in a circumferential area of the array substrate; and the sensing block is formed on a surface of the touch panel FPCA that faces the circumferential area of the array substrate and at a location to be exactly opposite to the driving block.

3. The method for a display panel to supply a sync signal to a touch panel as claimed in claim 1, wherein the driving block is a metal electrode.

4. The method for a display panel to supply a sync signal to a touch panel as claimed in claim 1, wherein the driving block is an indium tin oxide (ITO) electrode.

5. The method for a display panel to supply a sync signal to a touch panel as claimed in claim 1, wherein the sensing block is a metal electrode.

6. A circuit for a display panel to supply a sync signal to a touch panel, comprising a display drive integrated circuit (IC), a driving block connected via a lead wire to a sync signal output pin of the display drive IC, a sensing block opposite to the driving block, and a touch controller IC connected via a lead wire to the sensing block, the driving block and the sensing block constituting a capacitor C.

7. The circuit for a display panel to supply a sync signal to a touch panel as claimed in claim 6, wherein the driving block is formed on the display panel and the sensing block is formed on the touch panel at a location exactly corresponding to the driving block.

8. The circuit for a display panel to supply a sync signal to a touch panel as claimed in claim 7, wherein the display panel comprises an array substrate, a color filter substrate opposite to the array substrate, and a display panel flexible printed circuit assembly and the touch panel comprises a plurality of touch sensors and a touch panel FPCA electrically connected to the plurality of touch sensors, the touch panel FPCA being electrically connected to the touch controller IC; and
the driving block is arranged in a circumferential area of the array substrate; and the sensing block is formed on a surface of the touch panel FPCA that faces the circumferential area of the array substrate and at a location to be exactly opposite to the driving block.

9. The circuit for a display panel to supply a sync signal to a touch panel as claimed in claim 6, wherein the driving block is a metal electrode or an indium tin oxide (ITO) electrode.

10. The circuit for a display panel to supply a sync signal to a touch panel as claimed in claim 6, wherein the sensing block is a metal electrode.

11. A method for a display panel to supply a sync signal to a touch panel, comprising the following steps:
Step 1: providing a display panel and a touch panel, wherein the display panel comprises a display drive integrated circuit (IC) and the touch panel comprises a touch controller IC;
Step 2: forming a driving block on the display panel;
Step 3: connecting the driving block via a lead wire to a sync signal output pin of the display drive IC;
Step 4: forming a sensing block on the touch panel at a location exactly corresponding to the driving block so that the driving block and the sensing block form a capacitor C;
Step 5: connecting the sensing block via a lead wire to a sync signal input pin of the touch controller IC; and
Step 6: the display drive IC generating a sync signal in a horizontal blank interval or a vertical blank interval of the display panel and outputted through the sync signal output pin thereof to be sensed by the capacitor C to generate a sensing signal such that the sensing signal is transmitted to the touch controller IC to be sensed by a capacitor of the touch controller IC to obtain the sync signal;
wherein the display panel further comprises an array substrate, a color filter substrate opposite to the array substrate, and a display panel flexible printed circuit assembly (FPCA); and the touch panel further comprises a plurality of touch sensors and a touch panel FPCA electrically connected to the plurality of touch sensors, the touch panel FPCA being electrically connected to the touch controller IC; and
the driving block is arranged in a circumferential area of the array substrate; and the sensing block is formed on a surface of the touch panel FPCA that faces the circumferential area of the array substrate and at a location to be exactly opposite to the driving block;
wherein the driving block is a metal electrode; and
wherein the sensing block is a metal electrode.
